(19) United States
(12) Patent Application Publication
(10) Pub. No.: US 2003/0170509 A1
(43) Pub. Date: Sep. 11, 2003

(54) Method for operating a fuel cell, polymer electrolyte membrane fuel cell which works with the method and process for producing the fuel cell

(76) Inventors: Armin Datz, Poxdorf (DE); Harald Schmidt, Erlangen (DE)

Correspondence Address: LERNER AND GREENBERG, P.A., Post Office Box 2480, Hollywood, FL, 33022-2480, US

(21) Appl. No.: 10/403,860

(22) Filed: Mar. 31, 2003

Related U.S. Application Data
(63) Continuation of application No. PCT/DE01/03574, filed on Sep. 17, 2001.

(30) Foreign Application Priority Data
Sep. 29, 2000 (DE) 100 48 423.9

(51) Int. Cl. H01M 8/10; H01M 4/96; H01M 8/00; H01M 8/04

(52) U.S. Cl. 429/13; 429/32; 429/34; 429/42; 429/44; 429/12

(57) ABSTRACT

When operating known polymer electrolyte membrane fuel cells it has to be made sure that the phosphoric acid does not directly contact the metal bipolar plate of the fuel cell at high temperatures. In order to avoid such a contact, a sufficiently electroconducting intermediate layer is interposed between the membrane electrode unit and the bipolar plate of the fuel cell, which prevents the phosphoric acid or a mixture of phosphoric acid and water that may escape from the membrane-electrode unit from reaching the bipolar plate. For producing the fuel cell, at least a two-layer stratified structure is introduced which becomes more hydrophobic and more finely pored with increasing proximity to the bipolar plate.

### CROSS-REFERENCE TO RELATED APPLICATION

This application is a continuation of copending International Application No. PCT/DE01/03574, filed Sep. 17, 2001, which designated the United States and was not published in English.

### BACKGROUND OF THE INVENTION

### FIELD OF THE INVENTION

The invention relates to a method for operating a fuel cell and to a polymer electrolyte membrane fuel cell that works with the method, in particular a high-temperature polymer electrolyte membrane fuel cell. In addition, the invention also relates to a process for producing a polymer electrolyte membrane (PEM) fuel cell of this type, in particular for use in high-temperature environments, enabling a fuel cell of this type to operate with reduced levels of corrosion.

When a polymer electrolyte membrane fuel cell, which is generally referred to as a PEM fuel cell (polymer electrolyte membrane or proton exchange membrane), is operating, considerable benefits can be achieved by increasing the operating temperature from the current levels of 65° C. to 80° C. to temperatures of over 100° C., in particular 150° C. to 200° C. On account of a higher CO tolerance on the part of the electrodes, complex and extensive CO cleaning can be dispensed with in a high-temperature polymer electrolyte membrane (HT-PEM) fuel cell of this type with reformate operation. By way of example, membranes impregnated with phosphoric acid are a suitable electrolyte for use at high temperatures, having good electrolyte conductivity even without being moistened by water. Assemblies produced in this way from a membrane and an associated electrode are generally referred to as membrane electrode assembly (MEA).

However, a specific operating concept and/or configuration have to be selected for fuel cell stacks, which are referred to in the specialist field as stacks for short, to operate at elevated temperatures. The latter configuration requires suitable materials, which in particular are insensitive to corrosion.

Corrosion tests carried out in different concentrations of phosphoric acid (20-85%) at temperatures of up to 150° C. in a potential range from 0 to 1.1 volt demonstrate that no metallic material has sufficiently low corrosion current densities of less than 10⁻⁶A/cm² to ensure the required PEM service life of approximately 4,000 h for mobile applications in vehicles or approximately 50,000 h for stationary applications. The iron-based and nickel-base alloys that are usually used in the chemical industry for phosphoric acid applications without electrochemical potential have current densities of 10⁻⁴ A/cm². Only glassy carbon has a limited suitability for this application, but even in this case the corrosion current densities are too high at potentials around 1 volt.

The latter problem is also known specifically for the carbon materials of the bipolar plates used in phosphoric acid fuel cells (PAFCs). In this case, the corrosion current densities in idling mode and at low loads, i.e. at cell voltages of around 1 volt, are likewise too high. In PAFCs, the porous carbon materials are hydrophobized at the surface, in order to prevent water and/or phosphoric acid from passing into the pores, resulting in corrosion of the carbon.

Published, European Patent Application EP 1 009 051 A2 discloses a liquid-cooled PEM fuel cell, in which corrosion-resistant layers, in which electrically conductive particles are also dispersed in a polymer matrix, are applied to the bipolar plates, so that an electrical resistance of no greater than approximately 1 Ωcm is ensured. The same purpose is served by coatings on the interconnector in Japanese Abstract JP 55-182141 A, in which layers of this type are of a metallic nature and are to include a mixture of thermally stable and chemically stable constituents and also graphite.

### SUMMARY OF THE INVENTION

It is accordingly an object of the invention to provide a method for operating a fuel cell, a polymer electrolyte membrane fuel cell which works with the method and a process for producing the fuel cell which overcome the above-mentioned disadvantages of the prior art methods and devices of this general type, which prevents corrosion of the bipolar plate when a polymer electrolyte membrane (PEM) fuel cell is operating and to a structure of the PEM fuel cell which takes account of this requirement and a process for producing the fuel cell.

With the foregoing and other objects in view there is provided, in accordance with the invention, a method for operating a fuel cell. The method includes providing a polymer electrolyte membrane (PEM) fuel cell having a bipolar plate and a membrane electrode assembly with membranes impregnated with a liquid functioning as an electrolyte. An entry of the liquid being a corrosive liquid is prevented from coming into direct contact with the bipolar plate when operating the PEM fuel cell at elevated temperatures, and reaction water formed when the PEM fuel cell operates escapes in vapor form through pores at the elevated temperatures.

The operating method according to the invention ensures that when the fuel cell is operating at relatively high temperatures no corrosive liquid comes into direct contact with the bipolar plate. This applies in particular when phosphoric acid is used in the HT-PEM fuel cell.

In the fuel cell according to the invention, a sufficiently electrically conductive intermediate layer, which is formed from hydrophobized carbon papers or sheets with different porosities, is present between the membrane electrode assembly (MEA) and the bipolar plate, the intermediate layer becoming increasingly hydrophobic and at the same time having increasingly fine pores with increasing proximity to the bipolar plate. Particularly when a phosphoric acid-impregnated membrane is used, this prevents phosphoric acid which escapes from the MEA or phosphoric acid/water mixtures from reaching the bipolar plate, it being possible for the reaction water which forms when the fuel cell is operating to escape in vapor form through pores at elevated temperatures. It is preferable to select an at least two-layered structure.

In the production process according to the invention, for this purpose an intermediate layer is introduced between the membrane electrode assembly (MEA) and the bipolar plate. The intermediate layer must have a sufficient electrical conductivity and must be configured in such a way that it is impossible for any phosphoric acid or phosphoric acid/water mixtures to reach the bipolar plate. The intermediate layer inserted may be a multiple layer containing hydrophobized carbon papers or sheets. It is also possible for a carbon paper or the bipolar plate to be coated with a carbon/TEFLON mixture. By way of example, the known screen-printing technique or spraying processes are suitable for this purpose.

Other features which are considered as characteristic for the invention are set forth in the appended claims.

Although the invention is illustrated and described herein as embodied in a method for operating a fuel cell, a polymer electrolyte membrane fuel cell which works with the method and a process for producing the fuel cell, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a configuration in which there is a multilayered structure containing differently hydrophobized carbon paper or sheets according to the invention;

FIG. 2 is a sectional view showing a configuration in which the carbon layer has been applied to the a hydrophobized sheet in front of a bipolar plate of a fuel cell; and

FIG. 3 is a detailed sectional view showing an excerpt from FIG. 2 illustrating spikes.

### DESCRIPTION OF THE PREFERRED EMBODIMENTS

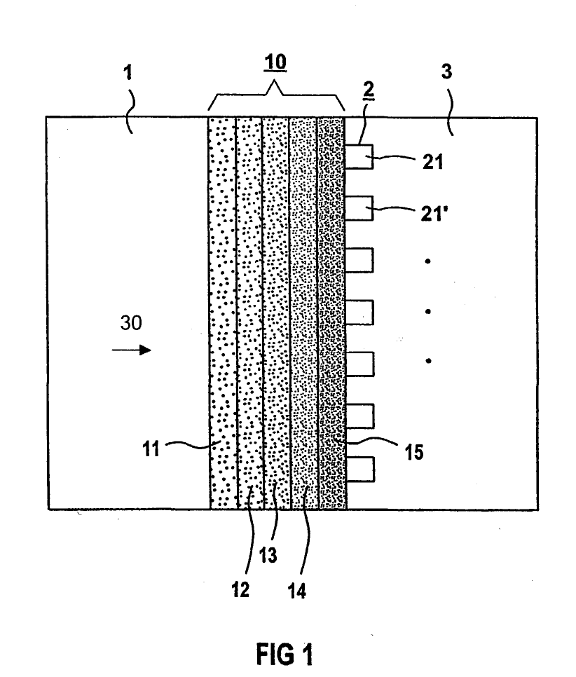

In all the figures of the drawing, sub-features and integral parts that correspond to one another bear the same reference symbol in each case. Referring now to the figures of the drawing in detail and first, particularly, to FIG. 1 thereof, there is shown a membrane electrode assembly 1 (MEA) of a known polymer electrolyte membrane (PEM) fuel cell, and a bipolar plate 3. In a region of the bipolar plate 3 there is a cooling system 2 with individual coolant passages 21, 21′, 21″ . . . through which a coolant can flow.

A configuration as shown in FIG. 1 having the membrane electrode assembly 1 and the bipolar plate 3, in combination with the further units, forms an individual fuel cell unit. A large number of fuel cell units form a fuel cell stack, which is also known in the specialist field as a stack for short. In the stack for a HT-PEM, it is necessary to keep the corrosion current densities for the bipolar plate at least below 10⁻⁵ A/cm², in particular below 10⁻⁶ A/cm². To enable inexpensive metallic materials to be used for this purpose, it is necessary to prevent phosphoric acid at a high temperature from coming into direct contact with the metallic bipolar plate 3.

For the latter purpose, in FIG. 1 an electrically conductive intermediate layer of sufficient conductivity has been introduced between the membrane electrode assembly 1 and the bipolar plate 3, preventing any phosphoric acid or phosphoric acid/water mixtures 30 that escape from the MEA 1 from reaching the bipolar plate 3.

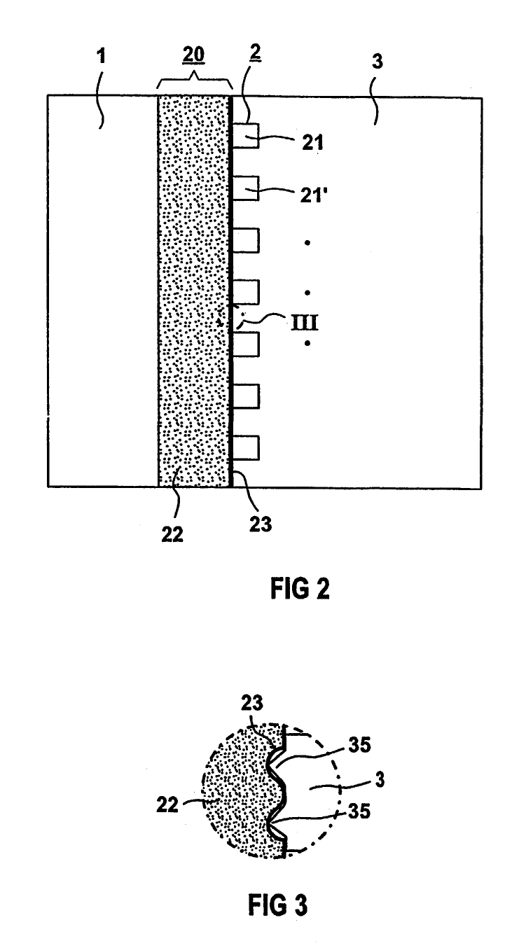

In FIGS. 1 and 2, the intermediate layer is a multilayer structure 10, which specifically, in FIG. 1, contains five layers of separate carbon papers or sheets 11 to 15. In this case, the individual layers of the carbon papers 11-15 become increasingly hydrophobic and, at the same time, have increasingly fine pores as their proximity to the bipolar plate 3 increases. In this way, the phosphoric acid or phosphoric acid/water mixture 30 is kept away from the bipolar plate 3.

To reliably ensure that this is the case, the intermediate layer is produced is at least a two-layered structure. Specifically, FIG. 2 shows a layer structure 20 that contains a carbon layer 22 of predetermined porosity and a hydrophobized sheet 23. As an alternative to the carbon layer 22 and the hydrophobic sheet 23 as shown in FIG. 2, an equivalent effect can also be achieved by coating carbon paper with a carbon/TEFLON mixture. A layer structure of this type can be produced, for example, by known screen-printing techniques.

Therefore, the described coating makes it possible to ensure that hydrophilic phosphoric acid or phosphoric acid/water mixtures 30 that escape from the MEA 1 only penetrate into the layers close to the MEA 1 and are blocked by the layer structure becoming increasingly hydrophobic toward the bipolar plate 3 before the acid can attack the bipolar plate 3. The reaction water that is formed at the HT-PEM operating temperature of approximately 160° C. can in this case escape in vapor form through pores that are present.

The electrical contact between the MEA 1 and the bipolar plate 3 may deteriorate on account of the hydrophobized sheet 23 in FIG. 2. This can be counteracted by providing the bipolar plate 3 with studs or spikes that are pressed into the hydrophobized sheet 23 and in this way improve the electrical contact in a punctiform manner. This is illustrated in FIG. 3 by points 35 on the bipolar plate 3.

In a further alternative, it is possible for a thin, electrically conductive, hydrophobic and acid-repellant layer to be applied directly to the bipolar plate 3. This can be achieved by spraying on a mixture formed of soluble amorphous TEFLON or a TEFLON dispersion and conductive carbon powder (e.g. Vulcan XC 72). The layer that has been sprayed on may have to be conditioned after it has dried.

The resources that are locally available are important in the various production processes that have been described above. Carbon papers usually have porosities of between 50 and 100 μm. With a layer structure as shown in FIG. 1, however, porosities of <10 μm, and in particular in the nanometer region, would be required toward the bipolar plate. If carbon paper of these levels of porosity is unavailable, the screen-printing technique will prove to be more suitable.

In all the examples, conductivities of less than 0.5 S×cm can be achieved in the layer structure. Higher conductivities are better, so that, with dimensions which are desired for the layer structure as shown in FIG. 1 or FIG. 2, sheet resistances of R_{F}<20 mΩ×cm⁻² result. Under these electrical boundary conditions, corrosion is effectively prevented, it being possible for the water to escape in vapor form while the phosphoric acid is retained.

When the operating methods described are used, in the HT-PEM it is also possible for bipolar plates made from inexpensive metallic materials that are easy to machine to be used in addition to bipolar plates made from graphite. Under the operating conditions of the HT-PEM, i.e. in the presence of an electrochemical potential and an operating temperature of approximately 160° C., these materials would normally be attacked by phosphoric acid that can escape from the membrane.

We claim:

1. A method for operating a fuel cell, which comprises the steps of:
providing a polymer electrolyte membrane (PEM) fuel cell having a bipolar plate and a membrane electrode assembly with membranes impregnated with a liquid functioning as an electrolyte; and
preventing an entry of the liquid being a corrosive liquid from coming into direct contact with the bipolar plate when operating the PEM fuel cell at elevated temperatures, and reaction water formed when the PEM fuel cell operates escapes in vapor form through pores at the elevated temperatures.

2. The operating method according to claim 1, which further comprises using phosphoric acid-impregnated membranes as the membranes, and one of a phosphoric acid and a phosphoric acid/water mixture being prevented from reaching the bipolar plate.

3. The operating method according to claim 1, which further comprises operating the PEM fuel cell at temperatures of approximately 160° C.

4. A polymer electrolyte membrane (PEM) fuel cell, comprising:
a membrane electrode assembly;
a bipolar plate; and
an intermediate layer of sufficient electrical conductivity disposed between said membrane electrode assembly and said bipolar plate, said intermediate layer formed by a hydrophobized carbon structure selected from the group consisting of hydrophobized carbon papers each with different porosities and hydrophobized carbon sheets each with different porosities, said intermediate layer containing said hydrophobized carbon papers becoming increasingly hydrophobic and having increasingly fine pores as a proximity to said bipolar plate increases.

5. The fuel cell according to claim 4, wherein said intermediate layer has a conductivity of at least 0.5 S×cm.

6. The fuel cell according to claim 4, wherein said hydrophobized carbon structure is formed as an at least two-layered structure.

7. A polymer electrolyte membrane fuel cell, comprising:
a membrane electrode assembly;
a bipolar plate; and
an intermediate layer of sufficient electrical conductivity disposed between said membrane electrode assembly and said bipolar plate, said intermediate layer being a coating formed of carbon paper with a carbon/TEFLON mixture.

8. A polymer electrolyte membrane (PEM) fuel cell, comprising:
a membrane electrode assembly;
a bipolar plate; and
an intermediate layer of sufficient electrical conductivity disposed between said membrane electrode assembly and said bipolar plate, said intermediate layer being a coating disposed on said bipolar plate and formed of a carbon/TEFLON mixture.

9. A polymer electrolyte membrane (PEM) fuel cell, comprising:
a membrane electrode assembly (MEA);
a bipolar plate; and
an intermediate layer of sufficient electrical conductivity disposed between said membrane electrode assembly and said bipolar plate, said intermediate layer is a two-layered structured formed of a hydrophobized sheet and a carbon layer having a predetermined porosity.

10. The fuel cell according to claim 9, wherein said bipolar plate has at least one of studs and spikes pressing into said intermediate layer.

11. A process for producing a fuel cell, which comprises the steps of:
providing a membrane electrode assembly and a bipolar plate;
building up an intermediate layer selected from the group consisting of hydrophobized carbon papers coated at least with carbon of a predetermined porosity and a hydrophobized sheet coated at least with carbon of a predetermined porosity;
introducing the intermediate layer having sufficient electrical conductivity between the membrane electrode assembly and the bipolar plate; and
coating at least one of the hydrophobized carbon papers and the bipolar plate with a carbon/TEFLON mixture.

12. The production process according to claim 11, which further comprises:
providing the membrane electrode assembly with an electrolyte containing phosphoric acid;
combining the intermediate layer such that the phosphoric acid escaping from the membrane electrode assembly or a phosphoric acid/water mixture do not reach the bipolar plate.

13. The production process according to claim 11, which further comprises using a screen-printing technique.

14. The production process according to claim 11, which further comprises:
producing the intermediate layer by spraying on a mixture of one of a soluble, amorphous TEFLON and a TEFLON dispersion and a conductive carbon powder.

15. The production process according to claim 14, which further comprises conditioning the layer that has been sprayed on after the layer has dried.

16. A polymer electrolyte membrane (PEM) high-temperature fuel cell, comprising:
a membrane electrode assembly;
a bipolar plate; and
an intermediate layer of sufficient electrical conductivity disposed between said membrane electrode assembly and said bipolar plate, said intermediate layer formed by a hydrophobized carbon structure selected from the group consisting of hydrophobized carbon papers each with different porosities and hydrophobized carbon sheets with different porosities, said intermediate layer containing said hydrophobized carbon structure becoming increasingly hydrophobic and having increasingly fine pores as a proximity to said bipolar plate increases.
